(19) United States
(12) Patent Application Publication
(10) Pub. No.: US 2015/0127517 A1
(43) Pub. Date: May 7, 2015

(54) METHODS AND APPARATUS FOR FACILITATING FAIRNETTING AND DISTRIBUTION OF CURRENCY TRADES

(71) Applicant: INTEGRAL DEVELOPMENT CORP., Palo Alto, CA (US)

(72) Inventors: Michael TESTA, Ridgewood, NJ (US); Vikas SRIVASTAVA, Palo Alto, CA (US); Michelle Yip CHEN, San Mateo, CA (US)

(21) Appl. No.: 14/453,547

(22) Filed: Aug. 6, 2014

Related U.S. Application Data
(63) Continuation of application No. 13/860,999, filed on Apr. 11, 2013.
(60) Provisional application No. 61/622,845, filed on Apr. 11, 2012.

(51) Int. Cl. G06Q 40/04

(52) U.S. Cl. CPC G06Q 40/04
USPC 705/37

(57) ABSTRACT

Methods and apparatuses are provided for facilitating fairnetting and the distribution of currency trades. In one example, the method may include: (i) estimating non-provided trade information for each trade type of aggregated sets of trades of a plurality of trades using a market mid-rate; (ii) determining a netted amount and a market amount to transact based on received trade information and the estimated non-provided trade information; (iii) executing one or more trades for the market amount at a market rate; and (iv) distributing the market amount and the netted amount proportionally amongst the plurality of trades.

### CROSS-REFERENCE TO RELATED APPLICATIONS

The present application is a continuation of U.S. patent application Ser. No. 13/860,999, filed Apr. 11, 2013, entitled “Methods and Apparatus for Facilitating Fairnetting and Distribution Currency Trades,” which claims the benefit of, U.S. Provisional Patent Application Ser. No. 61/622,845, filed Apr. 11, 2012, entitled “Methods and Apparatus for Facilitating Fairnetting and Distribution Currency Trades,” Both of these applications are hereby incorporated herein by reference.

The present application is also related to U.S. Provisional Patent Application Ser. No. 61/747,698, filed Dec. 31, 2012, entitled “Methods and Systems for Facilitating Financial Exchanges Between Liquidity Takers and Liquidity Providers” and U.S. Provisional Patent Application Ser. No. 61/799,490, filed Mar. 15, 2013, entitled “Methods and Systems for Facilitating Financial Exchanges Between Liquidity Takers and Liquidity Providers.” Both of these provisional patent applications are also hereby incorporated by reference.

### BACKGROUND

The disclosed aspects relate to communications amongst multiple users, sources, and providers associated with foreign exchange transactions over a network.

Currently, systems that facilitate a list or portfolio of FX transactions that may include multiple currency pairs, multiple value dates, and expressed in terms of either base or term currencies may not deliver best execution. The objectives of best execution include getting the most competitive price, minimizing transaction costs as well as market impact.

Thus, improved apparatus and methods for facilitating FX transactions in which trades are netted, executed, and distributed in a fair, efficient, and optimal manner are desired. As used herein, a “trade” may include, for example, a spot trade, a forward trade, a swap, a roll, and/or any additional types of trades known to those having ordinary skill in the art.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. I illustrates a block diagram of a network for facilitating currency transactions according to an aspect;

FIG. 2 illustrates a call flow diagram for operation of a currency exchange system according to an aspect;

FIG. 3 illustrates a flowchart for operation of a currency exchange system according to an aspect;

FIG. 4 illustrates another flowchart for operation of a currency exchange system according to an aspect;

FIG. 5 illustrates exemplary block diagram of an exchange system according to an aspect; and

FIG. 6 depicts a block diagram of an exemplary exchange system.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The processing of trades amongst user devices, sources, providers (e.g., liquidity providers (“LPs”)), through an exchange system may be accomplished through using one or more servers and over a network. As used in the following description, an application may include, but is not limited to, a program, and/or segments, modules, snippets, etc. of a program. In particular, the present aspects enable an exchange system and associated applications to facilitate FX transactions in which trades are netted, executed, and distributed in a fair manner. Participants in the FX market may engage in FX transactions for various reasons, such as but not limited to, security settlements, passive and/or active hedging, currency alpha, dividends, payments, speculative trades, etc. The participants have one or more objectives while engaging in FX transactions, such as but not limited to, minimizing transaction costs, obtaining a fair deal (e.g., no disadvantage in comparison to like positioned participants), efficient and accurate processing, etc.

The process described herein delivers efficiency, optimality, and fairness when executing a portfolio of currency trades. The innovations described herein include an end-to-end process containing a number of steps that starts and ends with the same list of trades plus executed spot and forward rates against one or more credit facilitators. This end-to-end process leverages a number of techniques that include netting of trades (netting forward trades at individual value dates, using base amounts or estimated amounts from term currencies, etc.) across the portfolio of trades, decomposing crosses, determining the amount that needs to be executed in the market, and providing optimality to the process. In addition, aggregating liquidity and providing price discovery on both spot and forward components ensures optimal best execution. Cleaning up residual amounts resulted from the estimation techniques is an innovative solution to a difficult problem. Lastly, using mid-rates (pre-trade) for netted amounts and proportionally allocating executed trades to the appropriate originating trade list ensures fairness.

FIG. 1 illustrates a currency transaction environment 100 including an exchange system 110, one or more users 102 (e.g., User(A) . . . User(N)), one or more providers 104 (e.g., provider(A) . . . provider(N)), and one or more sources 106 (e.g., source(A) . . . source(N)) operable to communicate through network 150. Provider(s) 104 may be in communication with exchange system 110. Provider 104 may include a buyer or seller of financial instruments. Each provider 104 may provide financial information to enter a trade. This financial information will hereafter be referred as the terms of the trade. Source 106 of the prices maybe a financial institution including portals or electronic order matching systems. For example, a source 106 may be a LP, a credit facilitator, etc. There may also be a plurality of sources 106 in communication with system 110.

The terms of the trade may depend on the nature of the financial transaction involved. The terms of transaction may include a currency pair, a base currency amount, a term currency amount, to buy or sell, the source of the prices, a value date, and other transaction specific details helpful for executing the transaction. In one aspect, where the trade is a spot market transaction, the transaction specific details may include the currency pair for which the transaction may be made. The provided terms of transaction may be stored in a database of providers.

A user 102 may be a third party, and may attempt to execute a trade. In one aspect, the user 102 may specify a user-defined component based on a preference of providers 104. Each user 102 may set or assign a user-preference status for each provider 104, regardless of the user-preference status assigned by another user 102. The terms of trade may be communicated to exchange system 110 and received using trade reception module 112.

Exchange system 110 may include modules to assist with pre-trade, trade execution, and post-trade procedures. Exchange system 110 may include reception module 112, trade organization module 114, trade netting module 120, trade execution module 124, credit facilitator module 130, and trade distribution module 132.

Reception module 112 may be operable to receive information from various components within the currency transaction environment 100 through network 150. In one aspect, reception module 112 may receive trade proposed rates from any of the providers 104 and/or sources 106. In another aspect, reception module 112 may receive trade requests from multiple users 102. Each trade request may include various terms, such as but not limited to, a currency pair, a base currency amount, a term currency amount, to buy or sell, the source of the prices, a value date, and other transaction specific details helpful for executing the transaction.

Trade organization module 114 may be operable to organize the received trades. In one aspect, trade organization module 114 may organize trades by currency pair 116. In another aspect, trade organization module 114 may organize trades by base amount requested to buy, base amount requested to sell, term amount requested to buy, term amount requested to sell. In an optional aspect, where a trade uses an intermediary currency to facilitate the trade, trade cross values 118 may also be organized. For example, where a trade has a base currency of Australian dollars and a term currency of Japanese yen (AUDJPY), then the trade cross 118 may include conversion values into Australian dollars (AUDUSD) and Japanese yen (USDJPY).

Trade netting module 120 may be operable to determine trade amounts that may be processed internally (e.g., between the received trade requests). In one aspect, trade netting module 120 may net out trade amounts based on provided trade terms. In another aspect, trade netting module 120 may estimate non-provided terms for each of the different types using a market mid-rate 122 value. In such an aspect, the market mid-rate 122 value may be derived from one or more proposed rates received from sources 106 and/or providers 104. Trade netting module 120 may result in a netted amount and a market amount 126 that remains after the trades have been netted internally using the estimated market mid-rate 122. Further, once a trade has been executed, trade organization module 114 and/or trade netting module 120 may break apart the organized and netted trades so as to provide trade amounts to each of the users 102.

Trade execution module 124 may be operable to determine a market rate 128 for a transaction involving the market amount 126. In one aspect, where trade crosses include use of one or more intermediary currencies, then trade execution module 124 may be further operable to perform one or more residual trades to clean up values remaining in the one or more intermediary currencies. In one aspect, a market rate 128 may be obtained from a provider 104 and/or source 106 and may be based at least partially on the market amount 126 to be transacted. In one aspect, the market rate 128 may be higher than the market mid-rate 122.

Trade distribution module 132 may be operable to divide the market amount among the trade participants (e.g., users 102) proportionally. In one aspect, trade distribution module 132 may divide the market amount among the trade participants using a pro rata system. In another aspect, trade distribution module 132 may apply a weighting factor for distribution to one or more trade participants (e.g., a user with a trade request that is 90% percentage larger than other user's trade requests may receive a weighted distribution of the market amount).

In operation, reception module 112 may receive currency trades manually entered by a client into the trade blotter and/or downloaded automatically (e.g., via a spreadsheet file). Trade organization module 114 and trade netting module 120 may then net across multiple accounts, currencies, and value dates to assist in manage risk and set up net amounts for optimal trade processing. In one aspect, exchange system may be operable to provide pre-trade system credit or other checks to allow the user 102 to select only “approved” LPs for certain trade requests on specific accounts (via streaming rates, RFQ or possibly anonymous trading). Pre-trade credit checks may be used where the final FX contracts may be booked as direct credit vs. bank LPs. In another aspect, use of a credit facilitator may alleviate the use of pre-trade credit checks since LPs would give-up trade details to the credit facilitator which then may face the client for credit purposes. Once pre-trade procedures are completed, the trade may be executed.

Trade execution module 124 may execute multiple types of trades (e.g., spot trades, forward trades, etc.). With spot trades, once trade organization module 114 and trade netting module 120 net the trades, trade execution module 124 may begin executing market amounts. In operation, the trades that get netted may not be executed in the market, but may be marked as “executed” internally using the market mid-rate 122 as determined before the market trade. That way, the netted trades are not subject to the market impact caused by the market trades. The remaining market amount 126 may be executed at a market bid/offer rate (e.g., market rate 128). Thereafter, the trades may be proportionally divided to the various accounts to ensure fairness of execution. In one aspect, use of a credit facilitator may allow for consolidation of all the tickets generated during the transaction process and may deliver one clean ticket per trade to the exchange system 110. With forward trades, spot trades may be rolled out to their respective value dates, without triggering an upfront cashflow. Generally, a swap combined with spot execution may create three contracts (spot, front leg of the swap, back leg of the swap). Unless the same spot rate may be used for the spot and the front leg of the swap, an upfront cashflow would result.

In one aspect, exchange system 110 may further include a credit facilitator module 130 to aggregate all spot tickets into one average spot rate. Continuing the above operational aspect, adjusted swap points may then be obtained for the original reference spot from different providers 104 and sources 106 via the credit facilitator 130 to roll the position, effectively canceling the initial spot trade using the front leg of the swap and, as such, leaving an outright trade between the client 102 and the credit facilitator 130. The spot to forward roll may involve the same or different trading counterparties. Clients 102 may specify the spot rate resulting from the spot execution part of the process, and the counterparty who trades the forwards may quote the (adjusted) outright forward points given that spot rate.

Continuing the above operational aspect, after trades are executed, trade distribution module 132, trade organization module 114 and/or trade netting module 120 may break down the trades into the original account details. In one aspect, trade distribution module 132 may send trade allocations to the dealing LP or credit facilitator 130 (if using a credit facilitator model). In one aspect, LPs (provider 104) may use internal allocation technology to download trade details from the exchange system 100. Additionally or in the alternative, a number of the providers 104s may use a manual process to enter trade details provided by exchange system 110 into their internal booking system. In one aspect, exchange system 110 may be used to maintain trade details for full reporting and detailed audit control.

As such, a system for facilitating currency trades is disclosed in which each trading party (e.g., user 102) receives a fair distribution of a netted trade amount. In other words, the system allows for netting of trades to improve efficiency and reduce transactions costs while also assuring each participate in the netted trade receives a distributed amount based on the market mid-rate for netted amounts and the market rate for the market amount. By not providing all the trade participates with a distribution based on the market rate, trade participants that provided a smaller amount do not receive an unfair benefit from a better market rate obtained by participants that provided a larger amount.

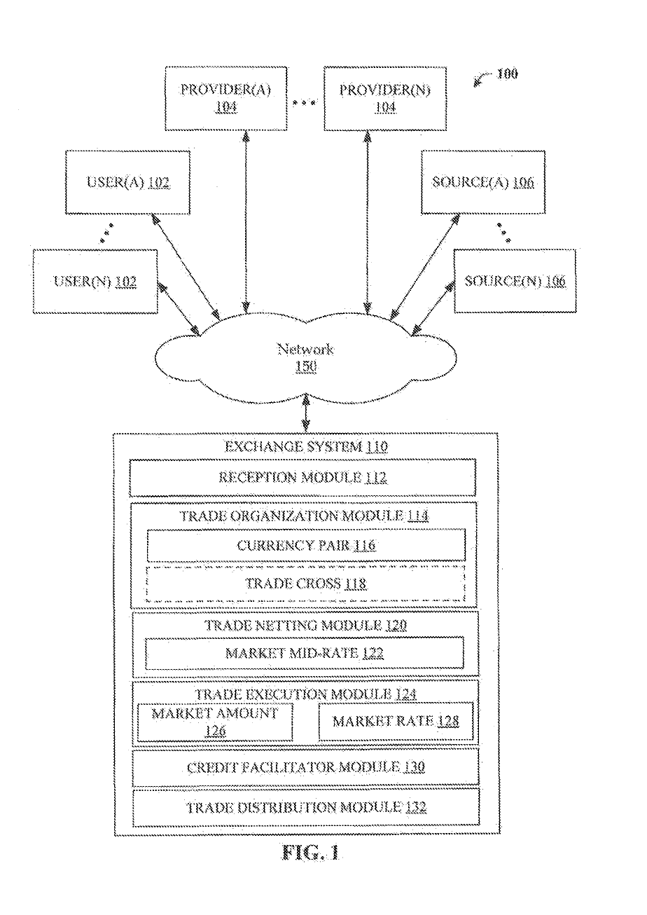

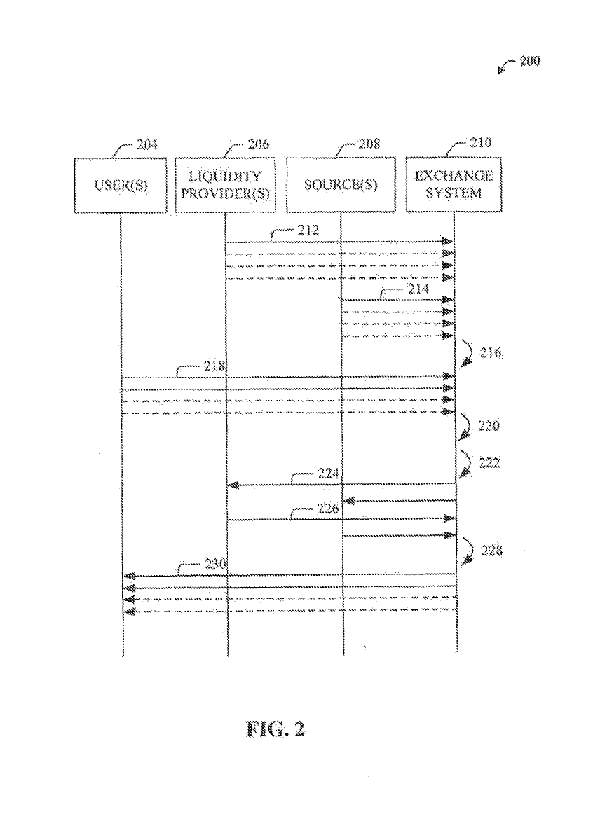

FIGS. 2-4 illustrate various methodologies III accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference to FIG. 2, operation of the subject matter depicted in FIG. 1 in the form of a message sequence diagram is illustrated. Specifically, with reference to FIG. 2, a currency exchange environment 200 in which interactions between a user 204 and an exchange system 210 is illustrated. Further, with reference to FIG. 2, interactions between at least one of liquidity providers 206 or sources 208 (e.g., credit facilitators) and the exchange system 210 are illustrated.

At acts 212 and 214, at least one liquidity provider 206 may provide a proposed rate of exchange between a currency pair. As depicted in FIG. 2, the liquidity provider 206 may provide multiple proposed rates and/or multiple liquidity providers 206 may each provide proposed rates. At act 216, exchange system 210 may process the received rate proposals and generate one or more market mid-rate values.

At act 218, at least one user 204 may send trade requests to exchange system 210. In one aspect, each trade request may include various terms, such as but not limited to, a currency pair, a base currency amount, a term currency amount, to buy or sell, the source of the prices, a value date, and other transaction specific details helpful for executing the transaction.

At act 220, exchange system 210 may organize the received trade requests into different trade types and aggregate the currency pair trades. As used herein, trade types may include requests to buy and/or sell at values provided in a base and/or term currency. Exchange system 210 may aggregate the received trades into currency pairs and may estimate non-provided values associated with the various received trade requests using the market mid-rate value. For example, where a trade request may include a sell request in a term currency, the market mid-rate value may be used to estimate a base currency value for the requested trade. At act 222, exchange system 210 may net out values internally to determine a market amount to be transacted with at least one of the liquidity providers 206 or a source 208. For example, where a first received trade request is to buy 2 million United States dollars against Australian dollars and a second trade request is to buy 1 million Australian dollars against United States dollars. The internal netting of the first trade and second trade may result in a market amount to complete the transactions.

At acts 224 and/or 226, exchange system 210 execute the market amount at market rates agreeable upon for the one or more transactions.

At act 228, exchange system 210 may divide the market amount among the trade requests from users 204 proportionally. In one aspect, exchange system 210 may further break down the aggregated trades and proportionally distribute the netted amount based on the market mid-rate and the market amount based on the market rate.

At act 230, the trade values may be transmitted back to the users 204 that provided the trade requests.

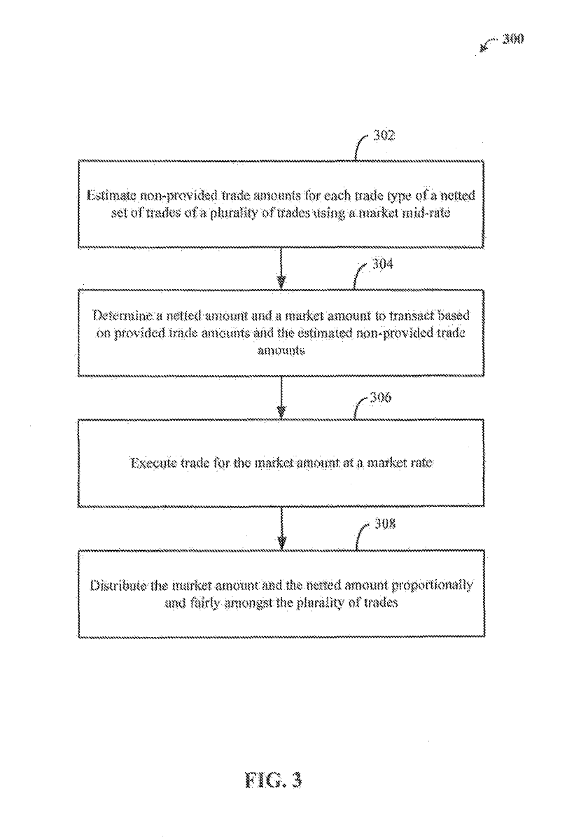

FIG. 3 illustrates an example currency transaction process 300, according to an aspect.

At block 302, an exchange system may estimate non-provided trade information for each trade type of aggregated sets of trades of a plurality of trades using a market mid-rate. In one aspect, the exchange system may receive the plurality of trades from one or more users, where each trade of the plurality of trades includes trade information. In such an aspect, information includes at least one of a currency pair, a base currency amount, a term currency amount, to buy or sell, a value date, etc. In one aspect, the market mid-rate may be determined from receiving one or more proposed transaction rates from one or more market entities, and determining the market mid-rate based on at least one of the one or more received proposed transaction rates. In such an aspect, market entities may be approved prior to participation in any trading. In another aspect, the aggregated sets of trades include trade crosses including at least one intermediary currency, and the exchange system may further estimate non-provided trade information for each of the at least one intermediary currency.

At block 304, the exchange system may determine a netted amount and a market amount to transact based on received trade information and the estimated non-provided trade information.

At block 306, the exchange system may execute one or more trades for the market amount at a market rate. In one aspect, the exchange system may further execute at least one residual trade to remove any value remaining in the at least one intermediary currency. In another aspect, at least one of the plurality of trades includes a forward trade, and the exchange system may further include means for executing a client specified spot swap for the forward trade. In such an aspect, a market entity used to execute the trade associated with the plurality of trades mayor may not be tied to which market entity that can be used for the forward trade.

At block 308, the exchange system may further distribute the market amount and the netted amount proportionally and/or fairly amongst the plurality of trades. In one aspect, the exchange system may use a pro-rata system to distribute the trades.

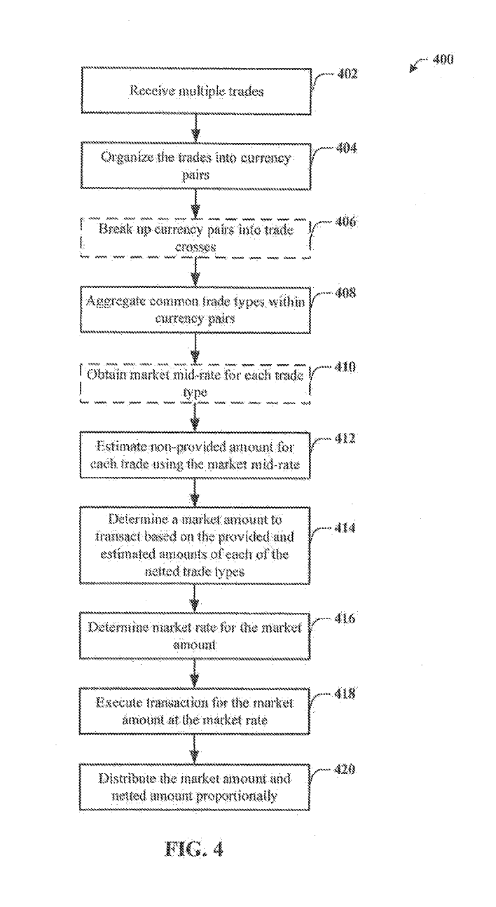

FIG. 4 illustrates another example currency transaction process 400, according to an aspect. The process 400 described herein may be performed by an exchange system and/or one or more systems in communication with each other, either directly or over a network (e.g., network 150).

At block 402, multiple trade requests may be received. In one aspect, an exchange system such as the exchange system depicted in FIG. 1 may receive the multiple trade requests from one or more users (e.g., users 102).

At block 404, the received trade requests may be organized into currency pairs. In an optional aspect, where the trade pairs include a need for use of an intermediary currency, then at block 406, the currency pairs may be broken up into trade crosses.

At block 408, the organized trade currency pairs may be aggregated.

In an optional aspect, at block 410, a market mid-rate for transactions associated with the currency pairs may be obtained. In one aspect, the market mid-rate may be derived from rate proposals provided by one or more sources 106, providers 104, etc.

At block 412, the market mid-rate may be used to estimate values that were not included in the trade request. For example, where a trade request includes a term amount using a term currency, then the market mid-rate may be used to estimate a base amount with a base currency.

At block 414, once the non-provided terms have been estimated, at least a portion of the trades may be internally netted out and may result in determining a market amount left after the netting.

At block 416, a market rate may be obtained for the proposed transaction for the market amount.

At block 418, one or more transactions for the market amount may be executed. Where a trade involved one or more intermediary currencies, then these transactions may be performed and any residual transactions may be executed to clean up the amounts remaining in an intermediary currency.

At block 420, the netted amount (e.g., based on the market mid-rate) and the market amount (based on the market rate) may be distributed among the parties from which the trades were received. In one aspect, the distribution may be performed in a pro rata manner assuring fairness for all trade participants while maintaining the efficiency obtained from trade netting.

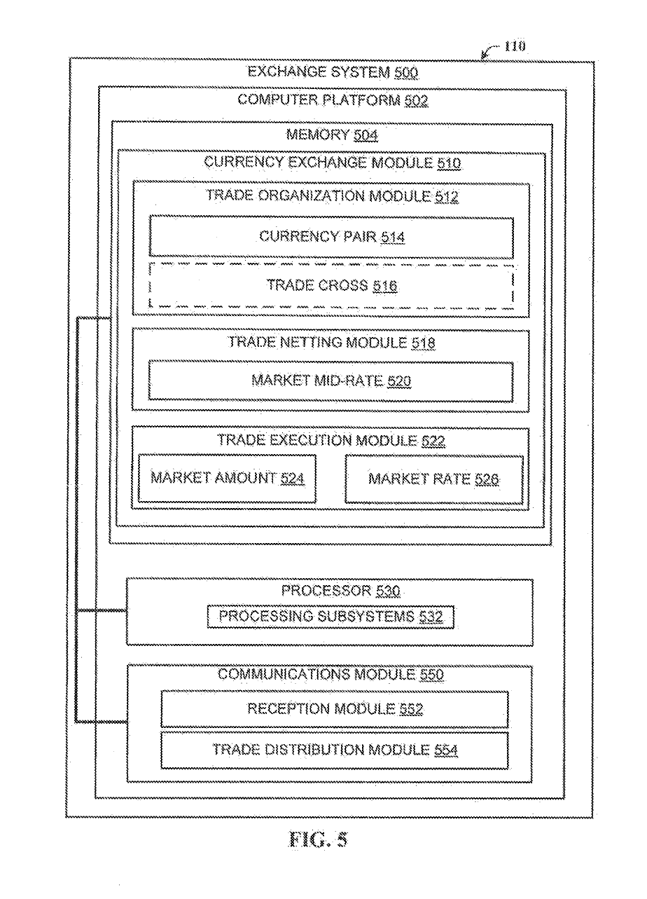

With reference to FIG. 5, illustrated is a detailed block diagram of an exchange system 500, such as exchange system 110 depicted in FIG. 1. Exchange system 500 may include at least one of any type of hardware, server, personal computer, mini-computer, mainframe computer, or any computing device either special purpose or general computing device. Further, the modules and applications described herein as being operated on or executed by exchange system 500 may be executed entirely on a single device, as shown in FIG. 5, or alternatively, in other aspects, separate servers, databases or computer devices may work in concert to provide data in usable formats to parties, and/or to provide a separate layer of control in the data flow between devices (e.g., 102, 104, 106) and the modules and applications executed by exchange system 500.

Exchange system 500 includes computer platform 502 that can transmit and receive data across wired and wireless networks, and that can execute routines and applications. Computer platform 502 includes memory 504, which may comprise volatile and nonvolatile memory such as read-only and/or random-access memory (ROM and RAM), EPROM, EEPROM, flash cards, or any memory common to computer platforms. Further, memory 504 may include one or more flash memory cells, or may be any secondary or tertiary storage device, such as magnetic media, optical media, tape, or soft or hard disk. Further, computer platform 502 also includes processor 530, which may be an application-specific integrated circuit (“ASIC”), or other chipset, logic circuit, or other data processing device. Processor 530 may include various processing subsystems 532 embodied in hardware, firmware, software, and combinations thereof, that enable the functionality of media content distribution system 14 and the operability of the network device on a wired or wireless network.

Processor 530, memory 504, currency exchange module 510, and/or communications module 550 may provide means for estimating non-provided trade information for each trade type of aggregated sets of trades of a plurality of trades using a market mid-rate, means for determining a netted amount and a market amount to transact based on provided trade information and the estimated non-provided trade information, means for executing one or more trades for the market amount at a market rate, and means for distributing the market amount and the netted amount proportionally amongst the plurality of trades.

Computer platform 502 further includes communications module 550 embodied in hardware, firmware, software, and combinations thereof, that enables communications among the various components of exchange system 500, as well as between exchange system 500, and devices 102, 104, 106. Communication module 550 may include the requisite hardware, firmware, software and/or combinations thereof for establishing a wireless and/or wired communication connection. Further, communication module 550 may include reception module 552 and trade distribution module 554. Reception module 552 may be operable to receive information from various components within the currency transaction environment 100 through network 150. In one aspect, reception module 552 may receive trade proposed rates from any of the providers 104 and/or sources 106. In another aspect, reception module 552 may receive trade requests from multiple users 102. Each trade request may include various terms, such as but not limited to, a currency pair, a base currency amount, a term currency amount, to buy or sell, the source of the prices, a value date, and other transaction specific details helpful for executing the transaction. Trade distribution module 554 may be operable to divide the market amount and netted amount among the trade participants (e.g., users 102) proportionally. In one aspect, trade distribution module 554 may divide the market amount among the trade participants using a pro rata system.

Memory 504 of exchange system 500 includes a currency exchange module 510 operable to facilitate FX transactions in which trades are netted, executed, and distributed in a fair and efficient manner across wireless or wired network 150. Currency exchange module 510 may include trade organization module 512, trade netting module 518, and trade execution module 522.

Trade organization module 512 may be operable to organize the received trades. In one aspect, trade organization module 512 may organize trades by currency pair 514. In another aspect, trade organization module 512 may organize trades by base amount requested to buy, base amount requested to sell, term amount requested to buy, term amount requested to sell. In an optional aspect, where a trade uses an intermediary currency to facilitate the trade, trade cross values 516 may also be organized. For example, where a trade has a base currency of Australian dollars and a term currency of Japanese yen (AUDJPY), then the trade cross 516 may include conversion values to Australian dollars (AUDUSD) and Japanese yen (USDJPY).

Trade netting module 518 may be operable to determine trade amounts that may be processed internally (e.g., between the received trade requests). In one aspect, trade netting module 518 may net out trade amounts based on provided trade terms. In another aspect, trade netting module 518 may estimate non-provided terms for each of the different types using a market mid-rate 520 value. In such an aspect, the market mid-rate 520 value may be derived from one or more proposed rates received from sources 106 and/or providers 104. Trade netting module 518 may result in a netted amount and a market amount 524 that remains after the trades have been netted internally using the estimated values and market mid-rate 520. Further, once a trade has been executed, trade organization module 512 and/or trade netting module 518 may break apart the organized and netted trades so as to provide trade amounts to each of the users 102.

Trade execution module 522 may be operable to determine a market rate 526 for a transaction involving the market amount 524. In one aspect, where trade crosses include use of one or more intermediary currencies, then trade execution module 522 may be further operable to perform one or more residual trades to clean up values remaining in the one or more intermediary currencies. In one aspect, a market rate 526 may be obtained from a provider 104 and/or source 106 and may be based at least partially on the market amount 524 to be transacted. In one aspect, the market rate 526 may be higher than the market mid-rate 520.

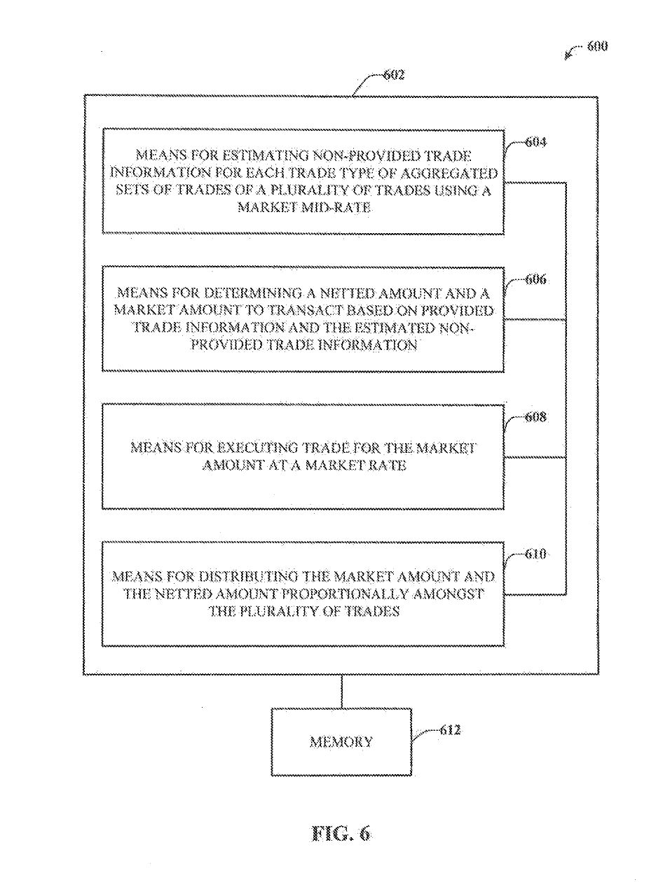

With reference to FIG. 6, a block diagram of an exemplary system 600 that can provide functionalities to one or more of a plurality of devices is illustrated. For example, system 600 can reside at least partially within a network server. According to another example aspect, system 600 can reside at least partially within an access terminal. It is to be appreciated that system 600 is represented as including functional blocks, which can be functional blocks that represent functions implemented by a processor, software, or combination thereof (e.g., firmware).

System 600 includes a logical grouping 602 of means that can act in conjunction. For instance, logical grouping 602 can include means for estimating non-provided trade information for each trade type of aggregated sets of trades of a plurality of trades using a market mid-rate 604. In one aspect, logical grouping 602 may further include means for receiving the plurality of trades from one or more users, wherein each trade of the plurality of trades includes trade information. In such an aspect, information includes at least one of a currency pair, a base currency amount, a term currency amount to buy or sell, a value date, etc. In one aspect, the market mid-rate may be determined using means for receiving one or more proposed transaction rates from one or more market entities, and means for determining the market mid-rate based on at least one or more received proposed transaction rates. In such an aspect, market entities may be approved prior to participation in any trading. In another aspect, the aggregated sets of trades include trade crosses including at least one intermediary currency, and the logical grouping 602 may further include means for estimating non-provided trade information for each of the at least one intermediary currency. Further, logical grouping 602 can comprise means for determining, by a processor associated with a currency exchange system, a netted amount and a market amount to transact based on received trade information and the estimated non-provided trade information 606. Further, logical grouping 602 can comprise means for executing one or more trades for the market amount at a market rate 608. In one aspect, the means for executing may include means for executing at least one residual trade to remove any value remaining in at least one intermediary currency. In another aspect, at least one of the plurality of trades includes a forward trade, and the means for executing may further include means for executing a client specified spot swap for the forward trade. In such an aspect, a market entity used to execute the trade associated with the plurality of trades may not be tied to which market entity can be used for the forward trade.

Further, logical grouping 602 can comprise means for distributing the market amount and the netted amount proportionally amongst the plurality of trades 610. In one aspect, the means for distributing may include means for using a pro rata system to distribute the trades. In one aspect, logical grouping 602 may further include means for using a credit facilitator to generate the aggregated sets of trades. In such an aspect, the credit facilitator may allow one to one mapping between an original trade list and the one or more executed trades. As such, a server may facilitate FX transactions in which trades are netted, executed, and distributed in a fair and efficient manner.

Additionally, system 600 can include a memory 612 that retains instructions for executing functions associated with the means 604, 606, 608, and 610. While shown as being external to memory 612, it is to be understood that one or more of the means 604, 606, 608, and 610 can exist within memory 612.

In one example, the functionality and system described herein may be embodied in a trading platform, such as the FX Inside™ platform offered by Applicant. Such a trading platform may be implemented via exchange systems 110/500, system 600, or any other suitable computing-system using techniques well-known in the art. In the discussion of such an exemplary platform that follows, it is important to bear in mind that the specific order in which certain processing is carried out is not critical. That is to say, the instant disclosure envisions performing the processing operations described below in any suitable order. Further still, in certain embodiments, the processing may include some, or all, of the processing operations described below. Stated another way, the instant disclosure envisions certain embodiments where only a single step of the processing is performed, embodiments where all of the processing steps are performed, and embodiments where some, but not all, of the processing steps are performed.

Initialization: Importing/Inputting Trade Information

In an example where the functionality and system described herein are embodied in a trading platform (e.g., a trading platform implemented as (i) one or more software modules, (ii) one or more hardware components (e.g., ASICs and the like), or (iii) some combination of hardware and software), a first step may involve providing an interface and processing capabilities for facilitating the importation/input of trade information into the platform. By way of example and not limitation, importing may include uploading an electronic file (e.g., a .xml, spreadsheet file) comprising trade information into the platform (e.g., by way of one or more APIs, or using other techniques known to those in the art). The trade information may include information describing one or more trades to be executed using the platform, as described in additional detail below.

As used herein, “trade information” may include, but is not limited to, information describing (1) a trade ID (i.e., a unique identifier associated with a particular trade); (2) a CCY pair (e.g., in an embodiment where the multi-purpose platform is being used to implement forex trading); (3) a “value,” or “execution,” date identifying the date on which a particular trade should be executed; (4) an indication of whether the trade is a “buy” or “sell” trade; (5) a dealt CCY value (again, in an example where the multi-purpose platform is being used to implement forex trading); (6) a deal amount describing the amount of the dealt CCY currency to be traded (again, in an example where the multi-purpose platform is being used to implement forex trading); (7) a base amount describing the amount in the base currency; (8) a term amount describing the amount in the term currency; (9) an account identifier identifying the party associated with the trade; and/or (10) an available credit amount identifying the amount of available credit associated with the account. While the foregoing description concentrated on “importing” the trade list information via, for example, an external file such as a spreadsheet, the instant disclosure also encompasses one or more embodiments that permit manual input of the trade information (such as the trade information described above) using techniques known in the art (e.g., a user may manually enter the trade information into the platform via, for example, user input devices and a graphical user interface).

Selection of a Netting Plan

Continuing, a next step may include providing an interface and processing capabilities for the selection of a netting plan. “Netting” refers to offsetting of buys and sells of like instruments against each other to reduce the market amount of trades. Appurtenant to the step of providing an interface for the selection of a particular netting plan from amongst a plurality of different netting plans are the designs of the respective netting plan themselves.

For example, a first selectable netting plan that may be provided via the platform described herein is a “simple netting” plan. When a user of the platform selects the simple netting plan option, the platform is operative to generate a transactional cost assessment describing the transactional costs associated with executing the portfolio of trades at issue utilizing the simple netting plan. Executing trades under the simple netting plan described herein involves netting all buy base vs. sell base trades, and netting all buy term vs. sell term trades. A user may settle on the simple netting plan for executing the trades (i.e., select the simple netting plan as the plan that will be used for executing the portfolio of trades) if doing so is desirable, or, alternatively, may select one of the other netting plans described below.

A second selectable netting plan that may be provided via the platform described herein is a “base/term netting” plan. As with the simple netting plan described above, when a user of the platform selects the base/term netting plan option, the platform is operative to generate a transactional cost assessment describing the transactional costs associated with executing the portfolio of trades at issue utilizing the base/term netting plan. Executing trades under the base/term netting plan described herein involves netting a total base amount (the aggregation of all of the base amounts for each respective trade in the portfolio imported/input into the platform) vs. the estimated base value of the trade specified in term currency.

A third selectable netting plan that may be provided via the platform described herein is a “base/term+cross CCY netting” plan. As with the two netting plans described above, when a user of the platform selects the base/term+cross CCY netting plan option, the platform is operative to generate a transactional cost assessment describing the transactional costs associated with executing the portfolio of trades at issue utilizing the base/term+cross CCY netting plan. Executing trades under the base/term+cross CCY netting plan described herein involves splitting any crosses (i.e., “cross currencies,” as that term is understood in the art) into an intermediary currency such as USD legs, and then netting the total base vs. the total term (in base equivalent units).

Thus, a user of the platform described herein may obtain a transactional costs assessment for executing a portfolio of trades under several different netting plans (e.g., one or more of the netting plans described above) prior to actually executing any trades. In this manner, a user may choose the optimal netting plan for their particular needs based in part on the transactional cost assessment that is generated by the platform. Further still, the exemplary platform described herein also includes a “refresh” feature (implemented, for example, via a radio button or the like embedded as part of the platform). Selecting (e.g., by a user) the “refresh” option from the netting plan selection interface causes the values affecting the transactional cost assessment to be updated to reflect the most up-to-date market rates available. For example, selecting the refresh option may cause the platform to obtain the most up-to-date (i.e., “real-time”) bid and offer rates. In this manner, a user may always compute estimated the transactional costs associated with the various netting plans using the most accurate, timely information available.

Net Forwards

An additional step may include providing an interface and processing capabilities for netting all or some of the forwards included as part of the portfolio of trades imported/input into the platform. Specifically, “netting forwards” may include taking trade mid-rate for each value date generated by the platform and assigning them to netted trades (without executing the trades in the market). An additional step may include further netting the spot component of the trades across value dates.

Execute Spots

Yet another step may include executing spot trades using at least one of the selected netting plans described above. In order to ensure that the spot trades are executed using the most up-to-date rates, in one example, a “refresh and execute” feature (implemented, for example, via a radio button or the like embedded as part of the platform) may be provided (e.g., by itself, or in addition to the “refresh” feature described above). The “refresh and execute” feature is operative to update the rates to the most up-to-date rates, and then facilitate execution of the trades.

In one example, if pre-trade mid-rate netting is configured, then a market mid rate may be calculated at the start of execution for netted amounts; otherwise, the market bid or offer rate will be used as the executed rate for the netted amounts. Once the spot trades are executed, the platform interface may be updated to populate an “executed spot rate” column, where each row in the column is associated with each of the one or more spot trades that were executed. The executed spot rate values populating this column reflect the actual spot rates at which the respective trades were executed.

Roll Forwards

Still another step may include rolling forwards. As known in the art, “rolling a forward” refers to the practice of extending the value date of a trade to a date in the future. One exemplary method of rolling a spot trade to a future value date is to enter into a swap where the front leg of the swap will completely cancel out the original spot trade, leaving the far leg of the swap as the outright. In order to avoid any cashflow differences on the spot date, it is necessary to ensure that the front leg of the swap has a spot rate that is identical to the original spot trade (fixed spot roll). In this exemplary step, the platform interface may display market forward amounts for fixed spot roll (FSR) function. The platform interface may also include a “roll” feature (implemented, for example, via a radio button or the like embedded as part of the platform). Selecting the roll feature via the interface causes the platform to generate a fixed spot roll request to providers.

Continuing with this step, a FSR may be executed for each currency pair (in an example where the platform is a forex platform) by value date. Adjusted forward points may be calculated and displayed via the interface, and “far rate” (rate on the far leg of the swap) may also be calculated and displayed via the interface.

True-Up Base/Term

Another additional step may include providing an interface and processing capabilities for performing “true-up.” As known in the art, performing a “true-up” refers to the process whereby a series of trades are executed to ensure that the proper amount is executed as per the request. This is necessary due to the fact that an estimated amount may have been calculated based on the netting plan selected, and that estimated amount could turn out to be slightly different from the requested amount. In order to provide for the “true-up” functionality, in this example, the platform interface may include a “true-up” feature (implemented, for example, via a radio button or the like embedded as part of the platform). Selecting the true-up feature will cause the platform to perform true-up operations, as described above, on some or all of the executed trades.

Respective columns on the platform interface may also be provided to indicate, for example, (1) what the true-up amount was for each respective trade that required a true-up, (2) the true-up rate that was used for each respective trade that required a true-up, and (3) a status column populated with values identifying whether or not each trade was fully filled following the true-up operation.

True-Up Cross Currency

Similar to the true-up functionality described above, in one example, another step may include performing a true-up operation on cross currency pairs. Specifically, any and/or all required cross currency true-up trades are calculated and executed via the platform to ensure that no vehicle CCY balances remain from splitting crosses and estimating base equivalents.

Furthermore, while the previous two steps discussed performing “true up base/term” and “true up cross currency,” respectively, those having ordinary skill in the art will appreciate that other, functionally equivalent, techniques may also be suitably employed for the purpose of resolving residual amounts generated as a result of using estimates in the netting step.

Export

An additional step may include providing an interface and processing capabilities for exporting executed trade information. As used herein, “executed trade information” may include all of the types of information disclosed above with regard to “trade information,” as well as additional information associated with each respective trade post-execution. For example, this additional information may include a listing of each of the following values for each trade: (1) spot rate, (2) forward points, and (3) all-in rate. In one example, the portfolio of executed trades may be re-organized for display within the platform interface based upon an average executed spot rate for market, netted, and residual portions of a given trade, whereby the netted amounts may be netted at either pre-trade mid rates or bid or offer rates, as described above. Further still, the information (including, but not limited to, the executed trade information) displayed as part of the platform interface may be delivered (e.g., exported) to a user in an accessible file format, such as a csv file format, or any other suitable file format known to those having ordinary skill in the art.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. An exchange system, comprising:
a reception module configured to receive trade information describing one or more trades to be executed;
a trade organization module configured to organize the one or more trades by currency pairs; and
a trade netting module configured to:
generate a plurality of netting plans, wherein each netting plan offsets at least one trade included in the one or more trades organized by currency pairs against at least one other trade included in the one or more trades organized by currency pairs to reduce the value of a market trade related to the one or more trades, and
estimate, for each netting plan, a total cost associated with executing the one or more trades according to the netting plan.

2. The exchange system of claim 1, wherein the reception module is further configured to receive a selection of a first netting plan included in the plurality of netting plans.

3. The exchange system of claim 2, wherein the total cost associated with executing the one or more trades according to the first netting plan is lower than the total costs associated with executing the one or more trades according to a second netting plan included in the plurality of netting plans.

4. The exchange system of claim 3, further comprising a trade execution module that is configured to execute the market trade based on the first netting plan.

5. The exchange system of claim 1, wherein a first netting plan included in the plurality of netting plans comprises a simple netting plan that:
nets all buy base trades included in the one or more trades against all sell base trades included in the one or more trades; and
nets all buy term trades included in the one or more trades against all sell term trades included in the one or more trades.

6. The exchange system of claim 1, wherein a first netting plan included in the plurality of netting plans comprises a base/term netting plan that:
identifies a first trade included in the one or more trades, wherein the first trade specifies a base amount expressed in a base currency of a currency pair;
identifies a second trade included in the one or more trades, wherein the second trade specifies a term amount expressed in a term currency of the currency pair;
generates a third trade that includes an estimated base amount expressed in the base currency corresponding to the term amount of the second trade; and
nets the first trade against the third trade.

7. The exchange system of claim 1, wherein a first netting plan included in the plurality of netting plans comprises a base/term plus cross-currency netting plan that:
identifies a first trade included in the one or more trades, wherein the first trade specifies a base currency and a term currency of a first currency pair;
splits the first trade into a second trade for a second currency pair associated with the base currency and an intermediate currency and a third trade for a third currency pair associated with the intermediate currency and the term currency; and
nets at least one of:
the second trade against a fourth trade included in the one or more trades, wherein the fourth trade corresponds to the second currency pair; and
the third trade against a fifth trade included in the one or more trades, wherein the fifth trade corresponds to the third currency pair.

8. The exchange system of claim 1, wherein the trade netting module is further configured to:
obtain current market rates associated with the one or more trades as the market rates change; and
update the total cost associated with executing the one or more trades estimated for each netting plan based on based on the current market rates.

9. A non-transitory computer-readable medium storing program instructions that, when executed by a processing unit, cause the processing unit to:
receive trade information describing one or more trades to be executed;
organize the one or more trades by currency pairs; and
generate a plurality of netting plans, wherein each netting plan offsets at least one trade included in the one or more trades organized by currency pairs against at least one other trade included in the one or more trades organized by currency pairs to reduce the value of a market trade related to the one or more trades, and
estimate, for each netting plan, a total cost associated with executing the one or more trades according to the netting plan.

10. The non-transitory computer-readable medium of claim 9, further storing program instructions that, when executed by a processing unit, cause the processing unit to receive a selection of a first netting plan included in the plurality of netting plans.

11. The non-transitory computer-readable medium of claim 10, wherein the total cost associated with executing the one or more trades according to the first netting plan is lower than the total costs associated with executing the one or more trades according to a second netting plan included in the plurality of netting plans.

12. The non-transitory computer-readable medium of claim 11, further storing program instructions that, when executed by a processing unit, cause the processing unit to execute the market trade based on the first netting plan.

13. The non-transitory computer-readable medium of claim 9, wherein a first netting plan included in the plurality of netting plans comprises a simple netting plan that:
nets all buy base trades included in the one or more trades against all sell base trades included in the one or more trades; and
nets all buy term trades included in the one or more trades against all sell term trades included in the one or more trades.

14. The non-transitory computer-readable medium of claim 9, wherein a first netting plan included in the plurality of netting plans comprises a base/term netting plan that:
identifies a first trade included in the one or more trades, wherein the first trade specifies a base amount expressed in a base currency of a currency pair;
identifies a second trade included in the one or more trades, wherein the second trade specifies a term amount expressed in a term currency of the currency pair;
generates a third trade that includes an estimated base amount expressed in the base currency corresponding to the term amount of the second trade; and
nets the first trade against the third trade.

15. The non-transitory computer-readable medium of claim 9, wherein a first netting plan included in the plurality of netting plans comprises a base/term plus cross-currency netting plan that:
identifies a first trade included in the one or more trades, wherein the first trade specifies a base currency and a term currency of a first currency pair;
splits the first trade into a second trade for a second currency pair associated with the base currency and an intermediate currency and a third trade for a third currency pair associated with the intermediate currency and the term currency; and
nets at least one of:
the second trade against a fourth trade included in the one or more trades, wherein the fourth trade corresponds to the second currency pair; and
the third trade against a fifth trade included in the one or more trades, wherein the fifth trade corresponds to the third currency pair.

16. The non-transitory computer-readable medium of claim 9, further storing program instructions that, when executed by a processing unit, cause the processing unit to:
obtain current market rates associated with the one or more trades as the market rates change; and
update the total cost associated with executing the one or more trades estimated for each netting plan based on based on the current market rates.

17. An exchange system, comprising:
a reception module configured to receive a request from a user device to roll a spot rate transaction associated with a current value date forward to a future value date; and
a trade execution module configured to:
generate a swap transaction associated with the future date that includes a front leg transaction and a back leg transaction,
fix a near rate associated with the front leg transaction such that no residual component remains after executing the spot rate transaction and the front leg transaction, and
transmit, to a provider device, at least one of a first quote request for the spot rate transaction, a second quote request for the front leg transaction based on the fixed near rate, and a third quote request for the back leg transaction.

18. The exchange system of claim 17, wherein the reception module is further configured to receive a quote for at least one of the spot transaction, the front leg transaction, and the back leg transaction from the provider device.

19. The exchange system of claim 17, wherein the trade execution module is further configured to execute at least one of the spot transaction, the front leg transaction, and the back leg transaction.

20. The exchange system of claim 17, wherein the trade execution module is further configured to cause adjusted forward points associated with the back leg transaction to be calculated.

21. The exchange system of claim 17, wherein the trade execution module is further configured to cause a far rate associated with the back leg transaction to be calculated.

22. A non-transitory computer-readable medium storing program instructions that, when executed by a processing unit, cause the processing unit to:
receive a request from a user device to roll a spot rate transaction associated with a current value date forward to a future value date; and
generate a swap transaction associated with the future date that includes a front leg transaction and a back leg transaction,
fix a near rate associated with the front leg transaction such that no residual component remains after executing the spot rate transaction and the front leg transaction, and
transmit, to a provider device, at least one of a first quote request for the spot rate transaction, a second quote request for the front leg transaction based on the fixed near rate, and a third quote request for the back leg transaction.

23. The non-transitory computer-readable medium of claim 22, further storing program instructions that, when executed by a processing unit, cause the processing unit to receive a quote for at least one of the spot transaction, the front leg transaction, and the back leg transaction from the provider device.

24. The non-transitory computer-readable medium of claim 22, further storing program instructions that, when executed by a processing unit, cause the processing unit to execute at least one of the spot transaction, the front leg transaction, and the back leg transaction.

25. The non-transitory computer-readable medium of claim 22, further storing program instructions that, when executed by a processing unit, cause the processing unit to calculate adjusted forward points associated with the back leg transaction.

26. The non-transitory computer-readable medium of claim 22, further storing program instructions that, when executed by a processing unit, cause the processing unit to calculate a far rate associated with the back leg transaction.
